(19) United States
(12) Patent Application Publication
(10) Pub. No.: US 2024/0248471 A1
(43) Pub. Date: Jul. 25, 2024

(54) MOVING ROBOT AND CONTROL METHOD THEREOF

(71) Applicant: SAMSUNG ELECTRONICS CO., LTD., Suwon-si (KR)

(72) Inventors: Minwoo RYU, Suwon-si (KR); Jinwook YOON, Suwon-si (KR); Taegyu KIM, Suwon-si (KR); Euihyun JUNG, Suwon-si (KR); Jihoon HA, Suwon-si (KR)

(73) Assignee: SAMSUNG ELECTRONICS CO., LTD., Suwon-si (KR)

(21) Appl. No.: 18/510,049

(22) Filed: Nov. 15, 2023

Related U.S. Application Data
(63) Continuation of application No. PCT/KR2023/017844, filed on Nov. 8, 2023.

(30) Foreign Application Priority Data
Jan. 25, 2023 (KR) 10-2023-0009652

(51) Int. Cl. G05D 1/02; A01D 34/00

(52) U.S. Cl. CPC G05D 1/0212; A01D 34/008; A01D 2101/00

(57) ABSTRACT

A moving robot including a main body; a plurality of wheels configured to rotate to move the main body; a blade provided to the main body and configured to be rotatable to cut grass; and at least one processor configured to obtain alignment direction information of a pattern by which the main body is movable based on pattern information and shape information of a work area, generate travel path information based on the obtained alignment direction information of the pattern, control the plurality of wheels to rotate to move the main body based on the generated travel path information, and control the blade to rotate to cut grass based on the generated travel path information.

### TECHNICAL FIELD

The disclosure relates to a moving robot capable of cutting grass in a work area while moving across the work area.

### BACKGROUND ART

Robots have been developed for industrial purposes and have been a part of factory automation. Recently, the application of robots has expanded to include medical robots, aerospace robots, service robots, and the like, and domestic robots for use at home are also being produced.

Among the robots, robots capable of autonomously driving are referred to as moving robots (mobile robots). A representative example of a moving robot is a Robotic Lawn Mower (RLM) used to mow and trim grass in residential yards, golf courses, and playgrounds.

For example, to mow the grass in a work area using a moving robot, an operator buried a wire at a boundary of the work area. In this case, the moving robot generates an induced current through a coil, and randomly travels within the work area while recognizing the wire using the generated induced current.

In another example, a moving robot performs communication with beacons installed in a work area, recognizes location information on a boundary of the work area, and travels within the work area based on the recognized location information of the boundary of the work area.

Such a moving robot includes a plurality of wheels provided in a lower portion of a main body and at least one blade provided in the main body, rotates the plurality of wheels to move in the work area, and rotates the at least one blade to mow an upper part of the grass.

### DISCLOSURE

### Technical Problem

The disclosure is directed to providing a moving robot that may obtain pattern alignment direction information of a work area and estimated working time information based on shape information and size information of the work area and selected pattern information, and output the pattern alignment direction information of the work area, the estimated working time information, and travel path information in the work area, and a control method thereof.

The disclosure is directed to providing a moving robot that may correct pattern alignment direction information of a work area in response to a user input, and a control method thereof.

### Technical Solution

Aspects of embodiments of the disclosure will be set forth in part in the description which follows and, in part, will be apparent from the description, or may be learned by practice of the presented embodiments.

According to an embodiment of the disclosure, a moving robot includes a main body: a plurality of wheels configured to rotate to move the main body: a blade provided to the main body and configured to be rotatable to cut grass: and at least one processor configured to obtain alignment direction information of a pattern by which the main body is movable based on pattern information and shape information of a work area, generate travel path information based on the obtained alignment direction information of the pattern, control the plurality of wheels to rotate to move the main body based on the generated travel path information, and control the blade to rotate to cut grass based on the generated travel path information.

According to an embodiment of the disclosure, the moving robot may further include a communicator configured to communicate with a plurality of beacons, each of which is located at different positions in the work area. The at least one processor is configured to, in response to receiving location information from the plurality of beacons, obtain the shape information of the work area and size information of the work area based on the received location information from the plurality of beacons.

According to an embodiment of the disclosure, the at least one processor may be configured to obtain the alignment direction information of the pattern that minimizes a working time for lawn care to be performed by the moving robot, based on the shape information of the work area, the size information of the work area, and the pattern information.

According to an embodiment of the disclosure, the at least one processor may be configured to obtain location information of a boundary based on the shape information of the work area, and obtain the alignment direction information of the pattern based on the obtained location information of the boundary and the pattern information.

According to an embodiment of the disclosure, the moving robot may further include an inputter configured to receive the pattern information.

According to an embodiment of the disclosure, the moving robot may further include a communicator configured to communicate with a plurality of beacons, each of which is located at different positions in the work area. The at least one processor is configured to, in response to receiving non-pattern information through the inputter, obtain current location information of the main body based on communication signals with the plurality of beacons, and generate the travel path information that minimizes a working time for lawn care to be performed by the moving robot, based on the obtained current location information of the main body, and the shape information of the work area.

According to an embodiment of the disclosure, the moving robot may further include a communicator configured to communicate with a user device; and a display. The at least one processor may be configured to control the display to display the obtained alignment direction information of the pattern, or control the communicator to transmit the obtained alignment direction information of the pattern to the user device.

According to an embodiment of the disclosure, the at least one processor may be configured to obtain estimated working time information based on the generated travel path information, and control the display to display the obtained estimated working time information.

According to an embodiment of the disclosure, the moving robot may further include an inputter configured to receive the pattern information. The at least one processor may be configured to, in response to receiving the alignment direction information of a pattern through the inputter, correct the received alignment direction information of the pattern in the work area, and control the display to display the corrected alignment direction information of the pattern in the work area.

According to an embodiment of the disclosure, the at least one processor may be configured to generate the travel path information based on the corrected alignment direction information of the pattern in the work area, obtain estimated working time information based on the generated travel path information, and control the display to display the obtained estimated working time information.

According to an embodiment of the disclosure, the at least one processor may be configured to, when controlling the plurality of wheels to rotate to move the main body based on the generated travel path information, control a rotational speed of the blade to be reduced in response to changing a traveling direction of the main body.

According to an embodiment of the disclosure, the moving robot may further include a communicator configured to communicate with a server. The at least one processor may be configured to, in response to a lawn care operation being completed, control the communicator to transmit at least one of the shape information of the work area, the pattern information, the alignment direction information of the pattern, and the generated travel path information to the server.

According to an embodiment of the disclosure, the at least one processor may be configured to receive at least one of the pattern information, the shape information of the work area, and size information of the work area from the server.

According to an embodiment of the disclosure, the at least one processor may be configured to control a rotational speed of the plurality of wheels based on the generated travel path information and the pattern information.

According to an embodiment of the disclosure, the moving robot may further include an inputter configured to receive the pattern information. The at least one processor may be configured to control a height of the blade, a rotational speed of the blade, and rotation and stoppage of the blade, based on an operation type received through the inputter, the pattern information, and the generated travel path information.

Another aspect of the disclosure provides a control method of a moving robot for lawn care including: in response to receiving pattern information through an inputter, obtaining alignment direction information of a pattern based on the received pattern information and shape information of a work area, generating travel path information based on the obtained alignment direction information of the pattern, obtaining estimated working time information based on the generated travel path information, controlling a display to display the obtained alignment direction information of the pattern and the obtained estimated working time information, and controlling an operation of a plurality of wheels and an operation of a blade based on the generated travel path information and the pattern information.

According to another aspect of the disclosure, the control method may further include performing communication with a plurality of beacons provided at different positions in the work area, and in response to receiving location information from the plurality of beacons, obtaining the shape information of the work area and size information of the work area based on the received location information of the plurality of beacons.

The obtaining of the alignment direction information of the pattern may include obtaining the alignment direction information of the pattern that minimizes a working time for lawn care, based on the shape information of the work area, the size information of the work area, and the pattern information, or obtaining location information of a boundary based on the shape information of the work area, and obtaining the alignment direction information of the pattern based on the obtained location information of the boundary and the pattern information.

According to another aspect of the disclosure, the control method may further include transmitting the obtained alignment direction information of the pattern and the obtained estimated working time information to a user device.

According to another aspect of the disclosure, the control method may further include, in response to receiving alignment direction information of a pattern through the inputter, correcting the alignment direction information of the pattern in the work area based on the received alignment direction information of the pattern, regenerating travel path information based on the corrected alignment direction information of the pattern in the work area, re-obtaining estimated working time information based on the regenerated travel path information, and controlling the display to display the corrected alignment direction information of the pattern in the work area and the re-obtained estimated working time information.

### Advantageous Effects

According to embodiments of the disclosure, a moving robot may mow a lawn in a pattern desired by a user, thereby providing the user with aesthetic satisfaction and optimizing lawn care work.

The moving robot may obtain an alignment direction of a pattern based on shape information of a work area, and mow a lawn in the pattern based on the obtained alignment direction of the pattern, thereby improving a stability of a lawn pattern formed in the work area.

The moving robot may obtain an alignment direction of a pattern that may minimize a working time based on shape information of a work area and pattern information, and mow a lawn in the pattern based on the obtained alignment direction of the pattern, thereby optimizing the working time.

The moving robot may display alignment direction information of a pattern of a work area through a display of the moving robot or a user device, thereby enabling a user to confirm the pattern to be mowed in the work area in advance.

The moving robot may accurately recognize a current location of the moving robot using Ultra-wideband-based Simultaneous Localization and Mapping (UWB-based SLAM) technology.

The moving robot may adjust a blade to a height desired by a user.

The moving robot may mow a lawn in a pattern based on an input of pattern information or text desired by a user, thereby providing an improved lawn care service.

The moving robot may store and manage alignment direction information of a pattern for each work area as well as for each pattern, thereby optimizing lawn care using the moving robot.

### DESCRIPTION OF DRAWINGS

These and/or other embodiments of the disclosure will become apparent and more readily appreciated from the following description of embodiments, taken in conjunction with the accompanying drawings of which:

FIG. 1 illustrates an example of communication of a moving robot according to an embodiment of the disclosure.

FIG. 2 is a perspective view of beacons and the moving robot according to an embodiment of the disclosure.

FIG. 3 is a front cross-sectional view of the moving robot according to an embodiment of the disclosure.

FIG. 4 is a bottom view of the moving robot according to an embodiment of the disclosure.

FIG. 5 is a schematic view of communication among the beacons and the moving robot according to an embodiment of the disclosure.

FIG. 6 illustrates an example of location information recognition of the moving robot according to an embodiment of the disclosure.

FIG. 7 is a control block diagram of the moving robot according to an embodiment of the disclosure.

FIG. 8 illustrates examples of pattern information that may be mowed in a work area by the moving robot according to an embodiment of the disclosure.

FIG. 9A illustrates an example of basic travel path information stored in the moving robot according to an embodiment of the disclosure.

FIG. 9B illustrates an example of corrected basic travel path information stored in the moving robot according to an embodiment of the disclosure.

FIG. 10A illustrates an example of displaying alignment direction information of a pattern in a work area recommended by the moving robot according to an embodiment of the disclosure.

FIG. 10B illustrates an example of corrected alignment direction information of the pattern shown in FIG. 10A.

FIG. 11 illustrates an example of travel path information of the moving robot according to an embodiment of the disclosure.

FIG. 12A, FIG. 12B, FIG. 13A, FIG. 13B, FIG. 14A and FIG. 14B illustrate examples of operation types of the moving robot according to an embodiment of the disclosure.

FIG. 15 is a flowchart of a control method of the moving robot according to an embodiment of the disclosure.

FIG. 16A and FIG. 16B illustrate an example of minimum time-based alignment direction information and travel path information of a pattern in a work area.

FIG. 17A and FIG. 17B illustrate an example of boundary-based alignment direction information and travel path information of a pattern in a work area.

FIG. 18A and FIG. 18B illustrate an example of initial posture-based alignment direction information and travel path information of a pattern in a work area.

### MODES OF THE DISCLOSURE

Various embodiments of the disclosure and terms used therein are not intended to limit the technical features described in the disclosure to particular embodiments, and it should be construed as including various modifications, equivalents, or alternatives of a corresponding embodiment.

With regard to description of drawings, similar reference numerals may be used for similar or related components.

A singular form of a noun corresponding to an item may include one item or a plurality of the items unless context clearly indicates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

It will be understood that the terms “first”, “second”, etc., may be used only to distinguish one component from another, not intended to limit the corresponding component in other aspects (e.g., importance or order).

It is said that one (e.g., first) component is “coupled” or “connected” to another (e.g., second) component, with or without the terms “functionally” or “communicatively”. When referenced, it means that one component may be connected to the other component directly (e.g., by wire), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when one component is referred to as being “on” or “over” another component, it may be directly on the other component or intervening components may also be present.

The term “and/or” includes any and all combinations of one or more of a plurality of associated listed items.

Hereinafter, an operation principle ad embodiments of the disclosure will be described in detail with reference to the accompanying drawings.

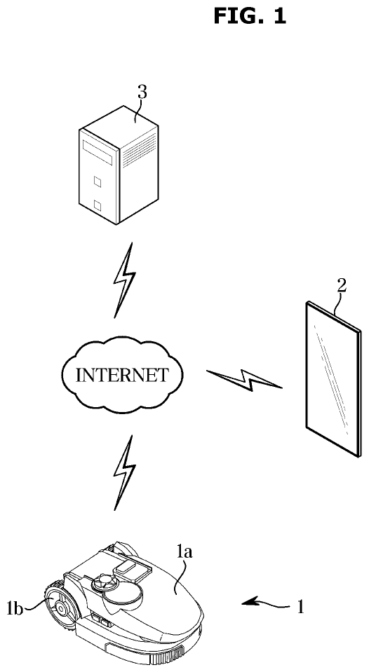

FIG. 1 illustrates an example of communication of a moving robot according to an embodiment.

A moving robot 1 may include a communication module capable of communicating with home appliances, a user device 2, or a server 3, a user interface receiving a user input or outputting information to a user, at least one processor controlling an operation of the moving robot 1, and at least one memory storing a program for controlling the operation of the moving robot 1.

The home appliance may be at least one of various types of electronic devices. For example, as shown in the drawing, the home appliance may include at least one of a refrigerator, a dishwasher, an electric range, an electric oven, an air conditioner, a clothing care apparatus, a washing machine, a dryer, and a microwave oven, without being limited thereto. For example, the home appliance may include various types of home appliances not shown in the drawing, such as a cleaning robot, a vacuum cleaner, a television, and the like.

Furthermore, the aforementioned home appliances are only examples, and in addition to the aforementioned home appliances, other home appliances connected to another electronic device, the user device 2 or the server 3 to perform operations described below may be included in the home appliances according to an embodiment.

The server 3 may include a communication module capable of communicating with the moving robot 1, another server, the home appliance, or the user device 2, at least one processor processing data received from the other server, the home appliance, or the user device 2, and at least one memory storing programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions such as managing a user account, registering the moving robot 1 in association with the user account, managing or controlling the registered moving robot 1, and the like. For example, a user may access the server 3 via the user device 2 and may generate a user account. The user account may be identified by an identifier (ID) and a password set by the user. The server 3 may register the moving robot 1 to the user account according to a predetermined procedure. For example, the server 3 may link identification information of the moving robot 1 (e.g., a serial number or MAC address) to the user account to register, manage, and control the moving robot 1.

The user device 2 may include a communication module capable of communicating with the moving robot 1, the home appliance, or the server 3, a user interface receiving a user input or outputting information to a user, at least one processor controlling an operation of the user device 2, and at least one memory storing a program for controlling the operation of the user device 2.

The user device 2 may be carried by a user, or placed in a user's home or office, or the like. The user device 2 may include a personal computer, a terminal, a portable telephone, a smartphone, a handheld device, a wearable device, and the like, without being limited thereto.

The memory of the user device 2 may store a program for controlling a user device 2, i.e. an application. The application may be sold installed on the user device 2, or may be downloaded from an external server for installation.

By executing the application installed on the user device 2 by a user, the user may access the server 3, generate a user account, and perform communication with the server 3 based on the login user account to register the moving robot 1 and the home appliance.

For example, by operating the moving robot 1 to access the moving robot 1 to the server 3 according to a procedure guided by the application installed on the user device 2, the server 3 may register the moving robot 1 with the user account by assigning the identification information (e.g., a serial number or MAC address) of the user device 2 to the corresponding user account.

A user may control the moving robot 1 using the application installed on the user device 2. For example, by logging into a user account with the application installed on the user device 2, the moving robot 1 registered in the user account appears, and by inputting a control command for the moving robot 1, the control command may be delivered to the moving robot 1 via the server 3.

A network may include both a wired network and a wireless network. The wired network may include a cable network or a telephone network, and the wireless network may include any networks transmitting and receiving a signal via radio waves. The wired network and the wireless network may be connected to each other.

The network may include a Wide Area Network (WAN) such as the Internet, a Local Area Network (LAN) formed around an Access Point (AP), and a short range wireless network not using an access point (AP). The short range wireless network may include Bluetooth™ (IEEE 802.15.1), Zigbee (IEEE 802.15.4), Wi-Fi Direct, Near Field Communication (NFC), and Z-Wave, without being limited thereto.

The AP may connect the moving robot 1, the home appliance, or the user device 2 to a WAN to which the server 3 is connected. The moving robot 1, the home appliance, or the user device 2 may be connected to the server 3 via the WAN.

The AP may communicate with the moving robot 1, the home appliance, or the user device 2 using wireless communication such as Wi-Fi™ (IEEE 802.11), Bluetooth™ (IEEE 802.15.1), Zigbee (IEEE 802.15.4), etc., and access a WAN using wired communication, without being limited thereto.

According to various embodiments, the moving robot 1 may be directly connected to the user device 2 or the server 3 without going through an AP.

The moving robot 1 may be connected to the user device 2 or the server 3 via a long range wireless network or a short range wireless network.

For example, the moving robot 1 may be connected to the user device 2 via a short range wireless network (e.g., Wi-Fi Direct).

In another example, the moving robot 1 may be connected to the user device 2 or the server 3 via a WAN using a long range wireless network (e.g., a cellular communication module).

In still another example, the moving robot 1 may access a WAN using wired communication, and may be connected to the user device 2 or the server 3 via the WAN.

Upon accessing a WAN using wired communication, the moving robot 1 may also serve as an access point. Accordingly, the moving robot 1 may connect the home appliance to the WAN to which the server 3 is connected. Further, the home appliance may connect the moving robot 1 to the WAN to which the server 3 is connected.

The moving robot 1 may transmit information about an operation or state to the home appliance, the user device 2, or the server 3 via the network. For example, the moving robot 1 may transmit information about an operation or state to the home appliance, the user device 2, or the server 3, upon receiving a request from the server 3, in response to an event in the moving robot 1, or periodically or in real time. In response to receiving the information about the operation or state from the moving robot 1, the server 3 may update the stored information about the operation or state of the moving robot 1 and transmit the updated information about the operation and state of the moving robot 1 to the user device 2 via the network. Here, updating the information may include various operations in which existing information is changed, such as adding new information to the existing information, replacing the existing information with new information, and the like.

The moving robot 1 may obtain various information from the home appliance, the user device 2, or the server 3, and may provide the obtained information to a user. For example, the moving robot 1 may obtain information related to a function of the moving robot 1 (e.g., recipes, washing instructions, etc.) and various environment information (e.g., weather, temperature, humidity, etc.) from the server 3, and may output the obtained information via a user interface.

The moving robot 1 may operate according to a control command received from the home appliance, the user device 2, or the server 3. For example, the moving robot 1 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, without being limited thereto.

The user device 2 may transmit information about a user to the moving robot 1, the home appliance, or the server 3 through the communication module. For example, the user device 2 may transmit information about a user's location, a user's health status, a user's preference, a user's schedule, etc. to the server 3. The user device 2 may transmit information about the user to the server 3 based on the user's prior authorization.

The moving robot 1, the home appliance, the user device 2, or the server 3 may use techniques such as artificial intelligence to determine a control command. For example, the server 3 may receive information about an operation or a state of the moving robot 1 or information about a user of the user device 2, process the received information using techniques such as artificial intelligence, and transmit a processing result or a control command to the moving robot 1 or the user device 2 based on the processing result.

Any robot capable of autonomous driving may be the moving robot 1 according to an embodiment. A robot for lawn mowing is described below as an example of the moving robot 1.

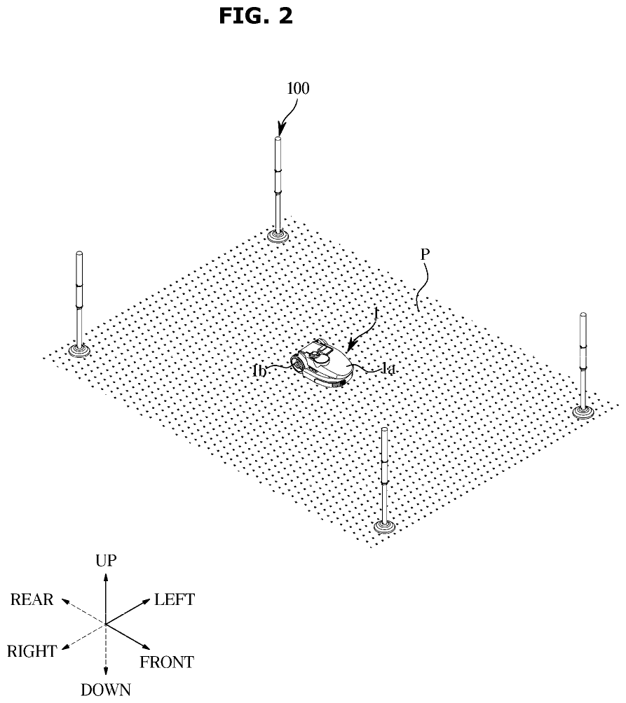

FIG. 2 is a perspective view of beacons and the moving robot according to an embodiment.

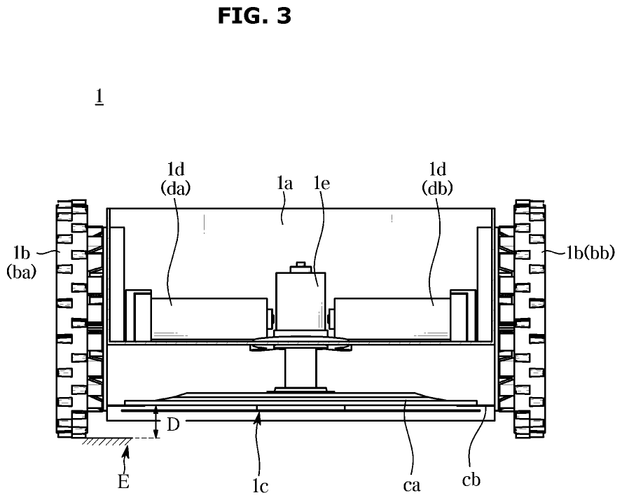

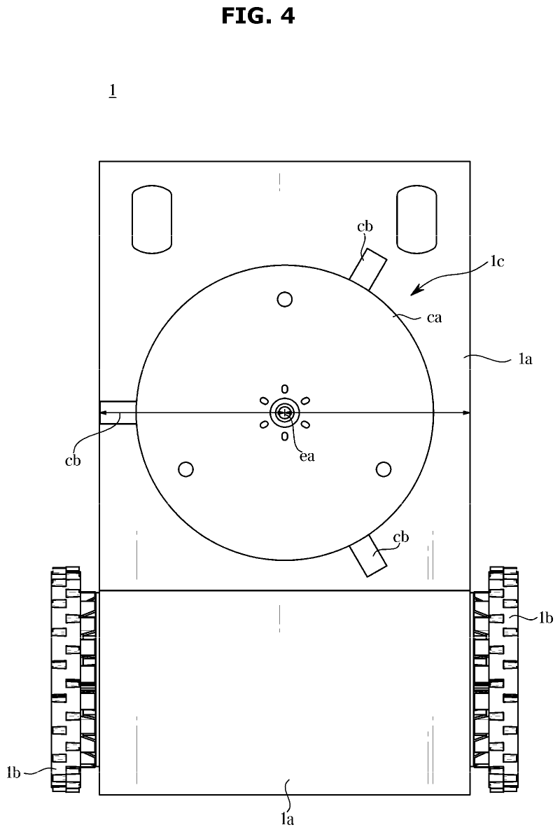

FIG. 3 is a front cross-sectional view of the moving robot according to an embodiment. FIG. 4 is a bottom view of the moving robot according to an embodiment.

As shown in FIG. 2, FIG. 3, and FIG. 4, the moving robot 1 may include a main body 1a forming an exterior, a plurality of wheels 1b provided at a lower portion of the main body 1a to be rotatable about an axis parallel to the ground and to move the main body 1a, and a blade 1c provided at the lower portion of the main body 1a to be rotatable about an axis perpendicular to the ground and to cut grass as a cutting member.

The moving robot 1 may further include a first motor 1d applying a rotational force to the plurality of wheels 1b, and a second motor 1e applying a rotational force to the blade 1c.

Meanwhile, the terms “front,” “upper portion,” “lower portion,” “left,” and “right” used in the following description are defined based on a forward movement direction of the moving robot, and a shape and a position of each component are not limited by these terms.

Terms referring to directions used in the following description, such as “front (F)/rear (R)/left (Le)/right (Ri)/up (U)/down (D)”, are defined as shown in the drawings. However, such terms are used to describe the disclosure for clear understanding, and each direction may be defined differently depending on the defining criteria.

The moving robot 1 may move across a lawn. The lawn may be a work area P of the moving robot 1.

A housing of the main body 1a may form an exterior of the moving robot 1.

The plurality of wheels 1b may be provided on sides of the housing of the main body 1a and may be rotatable. The plurality of wheels 1b may be provided on both sides of the housing of the main body 1a. The plurality of wheels 1b may include a plurality of protrusions.

Each of the plurality of wheels 1b may be connected to the first motor 1d provided inside the housing of the main body 1a.

The number of first motors 1d may be equal to the number of wheels. That is, in response to the plurality of wheels 1b, a plurality of first motors 1d may be provided.

The plurality of first motors 1d may be controlled at different rotational speeds.

The plurality of first motors Id may provide a driving force for driving the moving robot 1, and at the same time, the rotational speeds of the plurality of first motors 1d may be controlled to be different from each other by the processor 50. Due to a difference in rotational speed of the wheels 1b, a traveling direction of the moving robot may be adjusted.

The blade Ic may be connected to the second motor 1e provided inside the housing of the main body 1a.

Referring to FIG. 3, the second motor 1e may be disposed on a lower surface of the housing of the main body. The second motor 1e may be fixed to the housing and generate a driving force for rotating the blade 1c.

The blade Ic may include a rotation plate ca and a plurality of blades cb.

The rotation plate ca may be formed in a circular plate.

The rotation plate ca may be coupled to a blade drive shaft ea extending from the second motor 1e fixed to a frame inside the housing of the main body 1a. That is, the rotation plate ca is coupled to the blade drive shaft ea, and thus a driving force of the second motor 1e may be transferred to the rotation plate ca.

The plurality of blades cb may be provided on a boundary region of the rotation plate ca. The plurality of blades cb may be spaced apart from each other at regular intervals on the boundary region of the rotation plate ca.

The plurality of blades cb may be provided parallel to a rotational radial direction of the rotation plate ca rotated by the second motor 1e, and may be rotated by a rotational force of the rotation plate ca.

A cutting area formed by the blade Ic according to the rotation of the rotation plate ca may include an area corresponding to a width of the housing of the main body 1a.

The embodiment is described on an assumption that cutting may be performed only in an area where the blade Ic provided on the lower portion of the main body 1a of the moving robot passes.

The plurality of blades cb may be provided to be separable from the rotation plate ca.

The plurality of blades cb are separable from the rotation plate ca, thereby mitigating an impact generated during cutting due to a collision between the plurality of blades cb and an object to be cut. Accordingly, a durability of the blade Ic may be secured, and the plurality of blades cb worn during cutting for a long period of time may be easily replaced.

The blade Ic of the embodiment may move up and down based on a height of the main body 1a.

The blade Ic may be spaced apart from the ground E by a set distance D. Here, the set distance is a distance corresponding to a user command, and may be a distance corresponding to a height of the blade 1c.

The moving robot may adjust a grass cutting height in response to the height of the blade 1c. In other words, a pattern corresponding to the height of the mowed grass may appear in the work area.

Although not shown in FIG. 1 to FIG. 4, the moving robot 1 may further include a roller (not shown) or a striping kit (not shown) provided at a rear of the main body. The moving robot 1 may use the roller (not shown) or the striping kit (not shown) to flatten the grass (cause the grass to lie down) in a direction corresponding to a traveling direction of the moving robot 1.

A direction in which the grass lies down in the work area may lead to a difference in light reflected from grass blades. Accordingly, a person may see the grass lying down in the direction to which the moving robot travels, creating a sense of patterns formed in the work area. Here, ‘grass lying down’ refers to that the grass tilts at a certain angle.

That is, the reflection of light on the grass may vary depending on a length and an angle of the grass.

The moving robot 1 may mow a lawn in a pattern in the work area by adjusting the length and angle of the grass while cutting the grass.

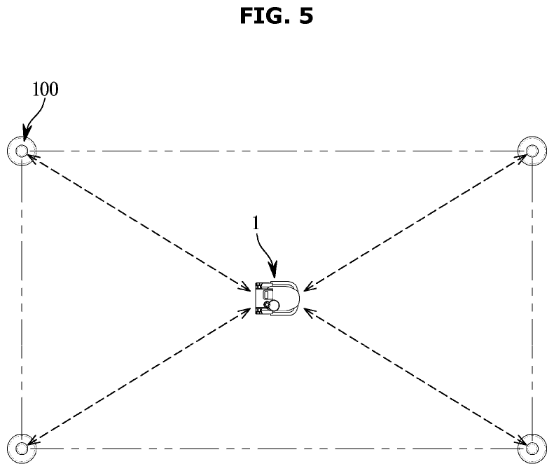

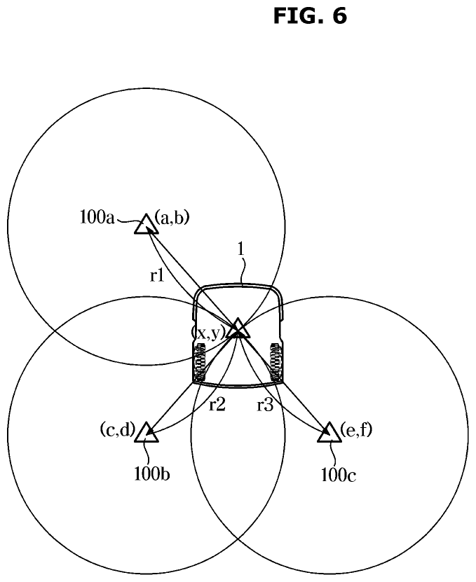

FIG. 5 is a schematic view of communication between the beacons and the moving robot according to an embodiment. FIG. 6 illustrates an example of location information recognition of the moving robot according to an embodiment.

Beacons 100 may be disposed at each boundary region of a work area P. The work area of the embodiment may be formed in a polygonal shape by the plurality of beacons 100.

For example, the work area P may be formed in a square by four beacons, and the work area P may be formed in a pentagon by five beacons. As such, the work area may have various shapes, and the shape of the work area may vary depending on the number of beacons.

The moving robot 1 may communicate with the plurality of beacons 100. The moving robot 1 may receive a signal from at least one of the plurality of beacons 100, and transmit a signal to at least one of the plurality of beacons 100.

The signal of the at least one beacon 100 received in the moving robot 1 may be an Ultra-wideband (UWB) communication signal, and the signal transmitted by the at least one beacon 100 to the moving robot 1 may include location information of the at least one beacon 100.

The plurality of beacons 100 may communicate with each other. In this case, each of the beacons 100 may measure a UWB communication distance with the moving robot 1 after measuring a relative coordinate system among the plurality of beacons 100. Each of the beacons 100 may measure a location of the moving robot 1 within the measured relative coordinate system through triangulation.

The moving robot 1 may measure a direction and a distance of a signal triggered from each of the beacons 100 disposed at a respective one of a plurality of fixed points, and may recognize the location of the moving robot 1 in the work area P based on the measured direction and distance of the signal.

The moving robot 1 may also recognize a current location of the moving robot 1 by using principles of Global Positioning System (GPS) based on location information of the beacons 100 received from three or more beacons 100.

In addition, the moving robot 1 may obtain an arrival time of a ultrasonic signal oscillated from a plurality of ultrasonic sensors of a charging station (not shown) based on a Radio Frequency (RF) signal emitted over a certain period of time, and obtain a distance and an angle between the charging station and the moving robot 1 based on the obtained arrival time, thereby recognizing the current location of the moving robot 1.

Referring to FIG. 5, the moving robot 1 may receive signals from the beacons 100 installed in the work area P. As described above, the signals of the beacons 100 received by the moving robot 1 may include location information of the beacons 100, and may further include identification information.

Each of the beacons 100 transmits a signal for generating a position coordinate system of the moving robot 1. The beacons 100 may support UWB communication of the moving robot 1.

For example, each of the beacons 100 may include a UWB antenna, and a Printed Board Assembly (hereinafter, referred to as “PBA”) that is connected to the UWB antenna and includes at least one device to control the beacons 100. The PBA may include a power circuit receiving power from a battery and supplying the power to the beacons 100.

The PBA may further include a function of Bluetooth (BLU) communication. In this case, the PBA may further include a BLE antenna.

Each of the beacons 100 may further include a cable for connecting at least one of the UWB antenna or the PBA. The cable may transmit an RF signal between the UWB antenna and the PBA. The cable may include a coaxial cable.

In response to receiving signals from three or more beacons 100, the moving robot 1 may recognize the current location of the moving robot 1 based on pre-stored location information of the beacons 100. Here, the pre-stored location information of the beacons 100 may be position coordinates, and may be information input by a user. That is, the moving robot 1 may recognize the position coordinates of the moving robot 1.

Referring to FIG. 6, the moving robot 1 may have pre-stored information about position coordinates of the first beacon 100a to the third beacon 100c, and in response to receiving signals from the first beacon 100a, the second beacon 100b, and the third beacon 100c, the moving robot 1 may recognize the position coordinates of the moving robot 1 through triangulation among the moving robot 1, the first beacon 100a, the second beacon 100b, and the third beacon 100c.

As shown in FIG. 6, based on the position coordinates of the moving robot 1 being (x, y), the position coordinates of the first beacon 100a being (a, b), and the position coordinates of the second beacon 100b being (c, d), the position coordinates of the third beacon (100c) being (e, f), and a distance between the moving robot 1 and each of the first beacon 100a, the second beacon 100b, and the third beacon 100c being r1, r2 and r3, respectively, the moving robot 1 may recognize the position coordinates (x, y) of the moving robot 1 according to Equation 1, Equation 2, and Equation 3 below.

Here, the position coordinates (x, y) of the moving robot 1 may be position coordinates of a communicator provided in the moving robot 1.

$${( x - a )}^{2} + {( y - b )}^{2} = r {1}^{2} \qquad [ Equation 1 ]$$

$${( x - c )}^{2} + {( y - d )}^{2} = r {2}^{2} \qquad [ Equation 2 ]$$

$${( x - e )}^{2} + {( y - f )}^{2} = r {3}^{2} \qquad [ Equation 3 ]$$

In this instance, processes of obtaining the distances r1, r2 and r3 between the moving robot 1 and each of the first beacon 100a, the second beacon 100b and the third beacon 100c may be the same. Accordingly, the process of obtaining the distance r1 between the first beacon 100a and the moving robot 1 is described below.

The first beacon 100a transmits a UWB pulse having a preset intensity (voltage) to the moving robot 1. In this instance, the moving robot 1 may receive a slightly distorted signal from the UWB pulse after a predetermined period of time T has elapsed, confirm a point in time at which the signal is received, and obtain the distance r1 between the moving robot 1 and the first beacon 100a by multiplying the confirmed point in time and a speed of radio wave (e.g., 300,000 km/s).

Here, the moving robot 1 and the first beacon 100a have synchronized timers.

In addition to the UWB signal, a signal used for location identification between the first beacon 100a and the moving robot 1 may include an infrared signal, an RF signal, and a Bluetooth signal, without being limited thereto.

In response to the current position coordinates being recognized, the moving robot 1 may control autonomous driving based on the recognized current position coordinates. That is, the moving robot 1 may move based on the beacons 100 provided in the work area, as shown in FIG. 2.

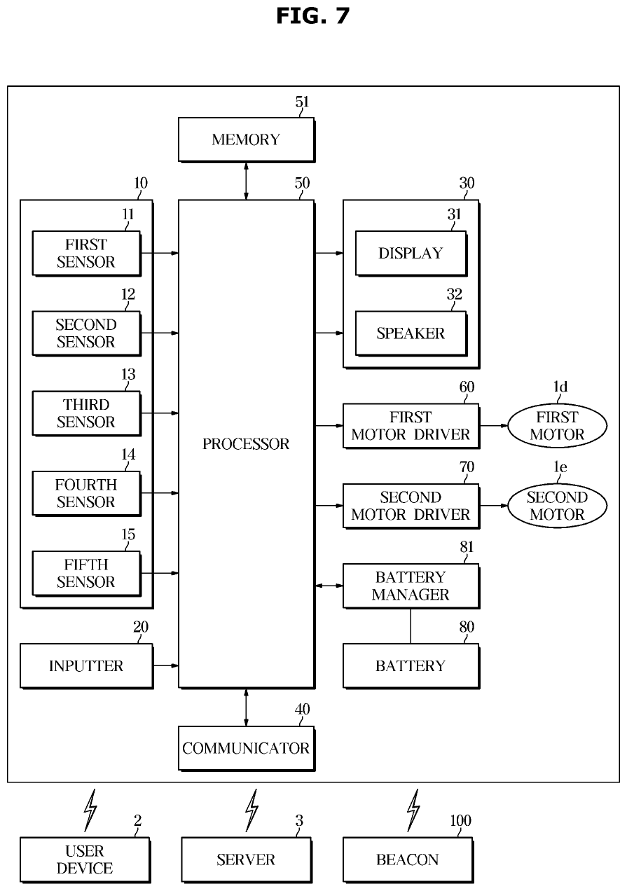

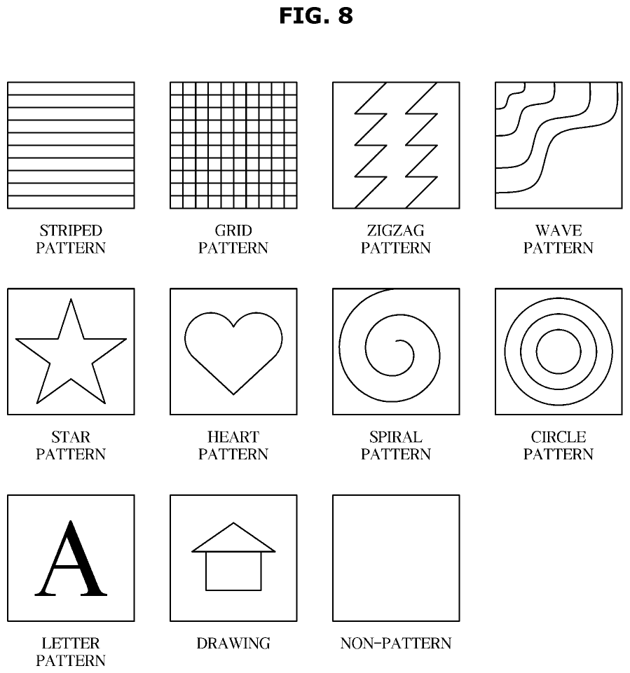

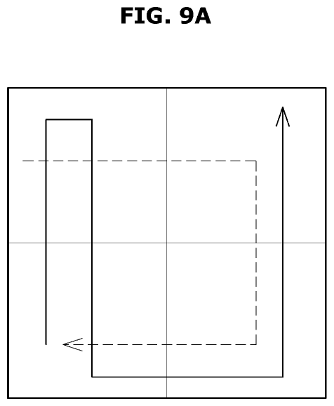

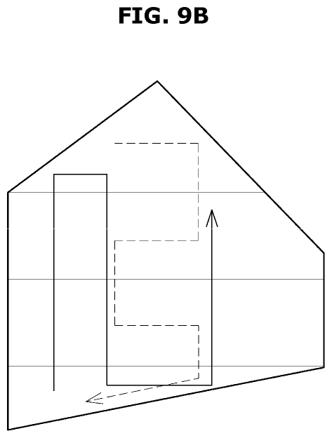

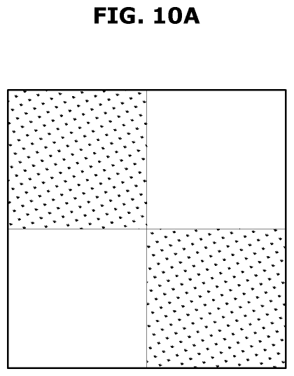

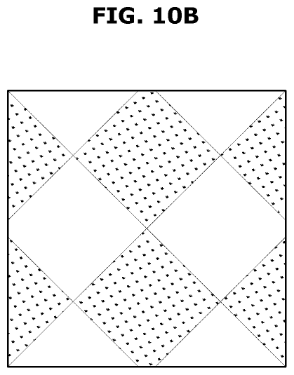

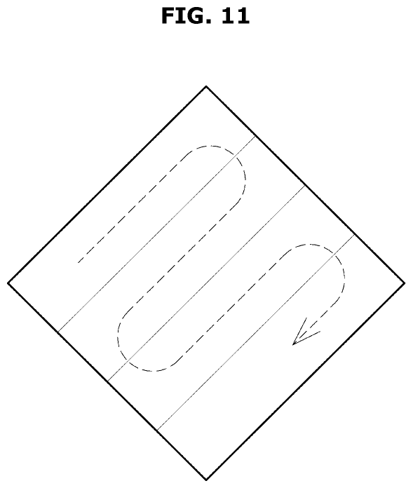

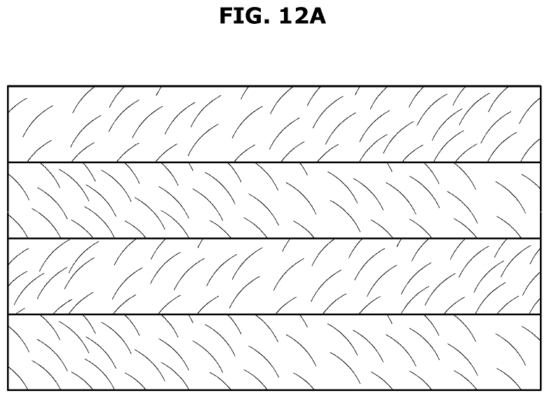

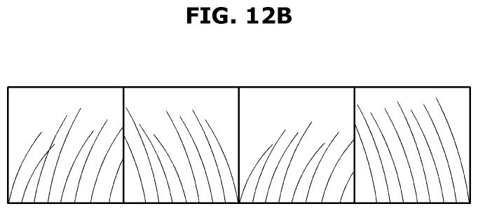

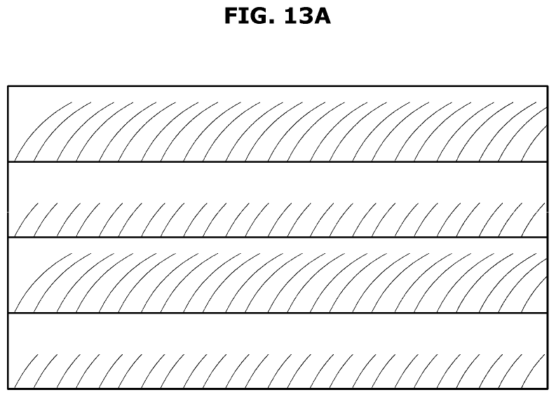

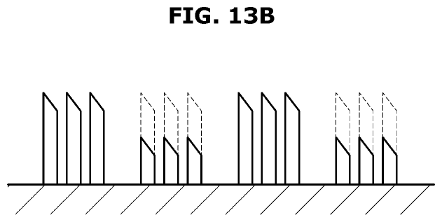

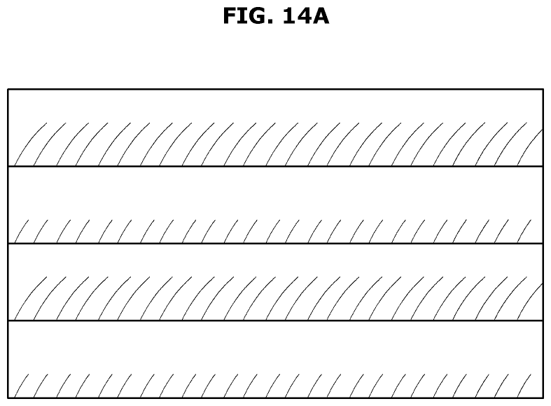

FIG. 7 is a control block diagram of the moving robot according to an embodiment, which is described with reference to FIG. 8, FIG. 9A, FIG. 9B, FIG. 10A, FIG. 10B, FIG. 11, FIG. 12A, FIG. 12B, FIG. 13A, FIG. 113B, FIG. 14A and FIG. 14B.

As shown in FIG. 7, the moving robot 1 may include a sensor 10, an inputter 20, an outputter 30, a communicator 40, the processor 50, and a memory 51. The moving robot 1 may further include a first motor driver 60 and a second motor driver 70, and may also further include a battery 80 and a battery manager 81.

The sensor 10 may detect environment information of a work area.

The environment information of the work area may include obstacle information in the work environment and boundary information of the work area.

The obstacle information may include location information and height information of an obstacle. The location information of the obstacle may include relative direction information and relative distance information with respect to the moving robot 1. The height information of the obstacle may include height information from ground level of the work area. The height information of the obstacle may also include depth information of the sunken ground.

The sensor 10 may include a first sensor 11 configured to detect the obstacle information.

One or two or more first sensors 11 may be provided.

The first sensor 11 may include one or two or more Light Detection and Ranging (Lidar) sensors. The lidar sensor is a non-contact distance detection sensor based on the principle of Laser Radar. Such lidar sensors have higher detection accuracy for a lateral direction, compared to Radio Detecting And Ranging (RaDAR) sensors.

The first sensor 11 may include one or two or more radar sensors. The radar sensor is a sensor that detects a location and a distance of an object using reflected waves generated by emission of radio waves, when both transmission and reception occur at the same location.

The first sensor 11 may include one or two or more ultrasonic sensors. The ultrasonic sensor generates ultrasonic waves for a certain period of time, and then detects a signal reflected back from an object. The ultrasonic sensor may be used to determine the presence or absence of obstacles within a short range.

The sensor 10 may include a second sensor 12 configured to obtain image information about an environment around the moving robot 1.

The second sensor 12 may include one or two or more image sensors. Here, the image information about the environment around the moving robot 1 may include image information about the environment in front of the moving robot.

The image sensor may include a plurality of photodiodes converting light into an electrical signal, and the plurality of photodiodes may be arranged in a two-dimensional (2D) matrix.

The image sensor may include a Complementary Metal Oxide Semiconductor (CMOS) image sensor or a Charge Coupled Device (CCD) image sensor, or may include a three-dimensional (3D) space detection sensor, such as a Kinect (RGB-D) sensor, a time-of-flight (TOF), a stereo camera, and the like.

The image sensor may include a camera.

The moving robot 1 may distinguish and recognize an inside and an outside of the work area using images obtained by the camera, and may recognize an obstacle in the work area. The moving robot 1 may recognize a shape, color, location, and the like of obstacle using the image obtained by the camera.

The moving robot 1 may also recognize images of the beacons 100 using the images obtained by the camera. Based on the recognized images of the beacons 100, the moving robot 1 may recognize boundary information of the work area, and also recognize current location information of the moving robot 1 in the work area.

The sensor 10 may detect state information and travel information of the moving robot 1.

For example, the state information of the moving robot 1 may include state-of-charge information of battery and error information. The travel information of the moving robot 1 may include travelable distance information, traveling speed information, and traveling direction information.

The sensor 10 may include a third sensor 13 configured to detect state-of-charge information of the battery 80.

One or two or more third sensors 13 may be provided.

The third sensor 13 may include a voltage sensor detecting a voltage at both ends of the battery, may further include a current sensor detecting a current flowing through the battery, and may also further include a temperature sensor detecting a temperature of the battery.

The sensor 10 may include a fourth sensor 14 configured to detect travel information of the moving robot. The fourth sensor 14 may include a first rotational speed sensor connected to the first motor 1d to detect a rotational speed of the first motor 1d.

One or two or more fourth sensors 14 may be provided. The number of fourth sensors 14 may be the same as the number of first motors 1d. That is, a plurality of first rotational speed sensors may be connected to a plurality of first motors 1d, respectively, to detect the respective rotational speed of the plurality of first motors 1d.

The sensor 10 may include a fifth sensor 15 configured to detect a rotational speed of the blade 1c. Here, the fifth sensor 15 may include a second rotational speed sensor connected to the second motor 1e to detect a rotational speed of the second motor 1e.

The inputter 20 may receive a user input.

For example, the user input may include a power on/off command for the moving robot, a command to start lawn care, a command to pause lawn care, a command to finish lawn care, a pattern display command, a pattern selection command, and a command to start correction, a command to cancel correction, and a command to finish correction.

The user input may include a pattern download command and a pattern upload command from any one of the server 3 and the user device 2.

The user input may further include a drawing command for a user to directly draw a pattern desired by the user.

The user input may further include drawing information of a pattern. The drawing information may include touch position information.

The user input may further include a command to select an operation type.

The operation type may include a first operation type that flattens grass by applying pressure, a second operation type that varies a grass height depending on whether cutting is performed or not, and a third operation type that changes a grass height according to a change in grass cutting height.

The first and second operation types are based on a traveling direction of the moving robot.

The third operation type is based on a difference in grass cutting height.

The third operation type may mow the grass in a more complex pattern, compared to the first and second operation types.

The inputter 20 may include a hardware device such as various buttons or switches, a pedal, a keyboard, a mouse, a trackball, various levers, a handle, a stick, and the like.

The inputter 20 may also include a Graphical User Interface (GUI) such as a touch pad, i.e., a software device. The touch pad may be implemented as a Touch Screen Panel (TSP) and form a mutual layer structure with the outputter.

The outputter may be used as an inputter as well, when implemented as the TSP forming a mutual layer structure with a touch pad.

The outputter 30 may output information corresponding to a user input, and may output travel information and state information of the moving robot.

For example, the outputter 30 may display error information, pattern information about a mowing pattern in the work area, state-of-charge information of battery, travelable distance information, traveling speed information, and traveling direction information.

The outputter 30 may include a display 31 for displaying various information as an image and a speaker 32 for outputting various information as sound.

The display 31 may be provided on an upper side of the main body 1a.

The display 31 may display pre-stored pattern information, pattern information selected by the user, alignment direction of a recommended pattern, and alignment direction of pattern corrected by the user.

The display 31 may display the amount of charge of the battery corresponding to the state-of-charge information of the battery and the travelable distance information. Here, the travelable distance information may be information about the amount of work that may be performed out of the total amount of work for the work area.

The display 31 may also display the number of battery charging times required for lawn care of the entire work area, and a charging time per charge of the battery.

The display 31 may display an estimated working time and an estimated work completion time required for lawn care of the entire work area.

The display 31 may display an estimated working time for each pattern, and may also display an estimated working time for each pattern alignment direction.

The display 31 may be provided as a Cathode Ray Tube (CRT) panel, a Digital Light Processing (DLP) panel, a Plasma Display Panel (PDP), a Liquid Crystal Display (LCD) panel, an Electroluminescent (EL) panel, an Electrophoretic Display (EPD) panel, an Electrochromic Display (ECD) panel, a Light Emitting Diode (LED) panel, an Organic LED (OLED) panel, and the like, without being limited thereto.

The communicator 40 may receive signals from the plurality of beacons 100. The signals of the beacons 100 may be Ultra-wideband (UWB) signals.

The signal of each of the beacons 100 may include location information of each of the beacons 100.

The communicator 40 for receiving the signals from the plurality of beacons may be implemented as at least one of the devices that may receive or read signals from a short distance, such as a Near Field Communication (NFC) module, a Radio Frequency Identification (RFID) reader, and the like.

The communicator 40 may include at least one component enabling communication with an external device, and may include, for example, at least one of a short-range communication module, a wired communication module, or a wireless communication module. Here, the external device may include the user device 2, the server 3, and the plurality of beacons 100, and may further include a router.

The communicator 40 may vary depending on a communication method of another device or server with which to communicate.

The short-range communication module may include a variety of short-range communication modules that transmit and receive signals in a short distance using a wireless communication network, such as a Bluetooth module, an infrared communication module, a Radio Frequency Identification (RFID) communication module, a Wireless Local Access Network (WLAN) communication module, a Near Field Communication (NFC) communication module, a Zigbee communication module, and the like.

The wired communication module may include various wired communication modules, such as a Local Area Network (LAN) module, a Wide Area Network (WAN) module, a Value Added Network (VAN) module, and the like, and may also include various cable communication modules, such as a Universal Serial Bus (USB), a High Definition Multimedia Interface (HDMI), a Digital Visual Interface (DVI), a Recommended Standard 232 (RS-232), power line communication, Plain Old Telephone Service (POTS), and the like.

The wireless communication module may include wireless communication modules supporting a variety of wireless communication methods such as Global System for Mobile communication (GSM), Code Division Multiple Access (CDMA), Wideband CDMA (WCDMA), Universal Mobile Telecommunications System (UMTS), Time Division Multiple Access (TDMA), Long-Term Evolution (LTE), and the like, in addition to a Wi-Fi module and a Wibro module.

The wireless communication module may include a wireless communication interface including an antenna and a transmitter for transmitting signals of the beacons 100. In addition, the wireless communication module may further include a first signal conversion module modulating a digital control signal output from the processor through the wireless communication interface into an analog wireless signal under the control of at least one processor.

The wireless communication module may include a wireless communication interface including an antenna and a receiver for receiving signals from the beacons 100. In addition, the wireless communication module may further include a second signal conversion module demodulating an analog wireless signal received through the wireless communication interface into a digital control signal.

The processor 50 may provide overall control related to operations of the moving robot 1. One or two or more processors 50 may be provided. That is, at least one processor 50 may be provided.

The processor 50 may perform control related to operations of the moving robot 1 using data stored in the memory 51.

The processor 50 may control autonomous driving and lawn care of the moving robot 1.

The lawn care may include cutting grass to a set height, maintaining a height of the grass, and applying pressure to the grass to cause the grass to lie at a certain angle in a traveling direction of the moving robot 1.

The processor 50 may process a sensor signal from the sensor 10, and signals from the inputter 20 and the communicator 40.

The processor 50 may receive a user input from the user device 2 and control an operation of the moving robot based on the received user input. The processor 50 may transmit operation information of the moving robot 1 to the user device 2, and display the operation information of the moving robot 1 through the user device 2.

The processor 50 may control an output of the outputter 30.

The processor 50 may adjust a height of the blade to a preset height or to a height corresponding to a user input.

The processor 50 may transmit control signals of the plurality of first motors 1d to the first motor driver 60, and transmit a control signal of the second motor 1e to the second motor driver 70 to control operations of the first motors 1d and the second motor 1e.

Operations of the processor 50 are described in more detail.

The processor 50 may control autonomous driving of the moving robot 1 based on sensing signals received from the sensors of the sensor 10.

The processor 50 may determine the presence or absence of an obstacle based on a sensing signal received from the first sensor 11, and based on a determination that the obstacle exists, obtain obstacle information based on the sensing information. The processor 50 may recognize shape information of the obstacle, distance information to the obstacle, and direction information of the obstacle based on the obtained obstacle information, and may control autonomous driving while avoiding the obstacle based on the recognized shape information, distance information, and direction information of the obstacle.

The processor 50 may obtain image information of the work area and image information of the obstacle based on a sensing signal received from the second sensor 12, and may control autonomous driving while avoiding the obstacle, based on the obtained image information of the work area and the obtained image information of the obstacle.

The processor 50 may confirm the state-of-charge information of the battery 80 based on a sensing signal received from the third sensor 13, and may determine whether the battery requires to be charged based on the confirmed state-of-charge information of the battery 80. Based on a determination that the battery requires to be charged, the processor 50 may communicate with a charging station (not shown), and control docking with the charging station (not shown) based on communication information with the charging station (not shown).

In response to receiving a command to start lawn care, the processor 50 may obtain information about the amount of work that may be performed, based on the state-of-charge information of the battery 80, and control the display 31 to display the obtained information about the amount of work.

Based on a determination that the battery 80 requires to be charged during lawn care, the processor 50 may control the outputter 30 to output notification information for charging, and control docking with the charging station (not shown).

The processor 50 may also receive the state-of-charge information of the battery 80 from the battery manager 81.

The processor 50 may obtain a rotational speed of the first motor 1d based on a sensing signal received from the fourth sensor 14 during lawn care, obtain a control signal of the first motor 1d based on the obtained rotational speed of the first motor 1d and a target rotational speed of the first motor 1d, and transmit the obtained control signal of the first motor 1d to the first motor driver 60.

The processor 50 may obtain a traveling direction of the moving robot based on pattern information and current location information of the moving robot during lawn care, and obtain a target rotational speed of the first motor 1d (da), connected to the left wheel 1b (ba), and a target rotational speed of the first motor 1d (db), connected to the right wheel 1b (bb), based on the obtained traveling direction of the moving robot. The processor 50 may transmit a control signal corresponding to the obtained target rotational speed of the first motor 1d (da), connected to the left wheel 1b (ba), to the first motor driver 60 for controlling the first motor 1d (da) connected to the left wheel 1b (ba), and may transmit a control signal corresponding to the obtained target rotational speed of the first motor 1d (db), connected to the right wheel 1b (bb), to the first motor driver 60 for controlling the first motor 1d (db) connected to the right wheel 1b (bb).

The processor 50 may obtain a rotational speed of the second motor 1e based on a sensing signal received from the fifth sensor 15 during lawn care, obtain a control signal of the second motor 1e based on the obtained rotational speed of the second motor 1e and a target rotational speed of the second motor 1e, and transmit the obtained control signal of the second motor 1e to the second motor driver 70.

In response to the traveling direction of the moving robot being about to change, the processor 50 may control the target rotational speed of the second motor 1e to be reduced. In this case, the processor 50 may transmit a control signal of the second motor 1e corresponding to the reduced target rotational speed to the second motor driver 70.

Upon changing the traveling direction of the moving robot, the processor 50 may obtain a rotation angle of the moving robot corresponding to the traveling direction to be changed, obtain a target rotational speed of the second motor 1e corresponding to the obtained rotation angle of the moving robot, and transmit a control signal of the second motor 1e corresponding to the obtained target rotational speed to the second motor driver 70.

In response to the traveling direction of the moving robot being completely changed, the processor 50 may increase the reduced target rotational speed of the second motor 1e, and transmit a control signal of the second motor 1e corresponding to the increased target rotational speed to the second motor driver 70.

Increasing the target rotational speed of the second motor 1e refers to controlling the target rotational speed of the second motor 1e to the original target rotational speed before reduction.

In addition, the processor 50 may stop the second motor 1e while changing the traveling direction of the moving robot 1. In this case, the processor 50 may transmit a control signal for stopping the rotation of the second motor 1e to the second motor driver 70.

The processor 50 may control communication with the plurality of beacons 100, and recognize a current location of the moving robot based on location information of the beacons received from the plurality of beacons 100. That is, the processor 50 may recognize the current location of the moving robot using Simultaneous Localization And Mapping (SLAM) based on Ultra-wideband (UWB) communication.

In response to receiving a command to start lawn care from the inputter 20, the processor 50 may control at least one of operations of traveling, cutting, or pressing of the moving robot.

In response to receiving a command to pause lawn care from the inputter 20, the processor 50 may control the traveling, cutting, and pressing operations of the moving robot to stop, until a command to start lawn care is received. That is, in response to receiving a command to start lawn care from the inputter 20 while the lawn care is temporarily stopped, the processor 50 may control at least one of the operations of traveling, cutting, or pressing of the moving robot again.

In response to receiving a command to finish lawn care from the inputter 20, the processor 50 may control the traveling, cutting, and pressing operations of the moving robot to stop, and control docking to the charging station.

In response to receiving a power-on command through the inputter 20, the processor 50 may activate the display 31.

In response to receiving a pattern display command through the inputter 20, the processor 50 may control the display 31 to display pattern information selectable by a user. Here, the pattern information may include information about a shape of pattern or a type of pattern.

As shown in FIG. 8, the pattern information selectable by the user may be information about a pattern to be made in a work area, and include pattern information pre-stored in the memory 51.

As shown in FIG. 8, the pattern information selectable by the user may further include non-pattern information and drawing information obtained by directly drawing a desired pattern by the user.

In response to receiving a pattern selection command through the inputter 20, the processor 50 may control the display 31 to display pattern information selected by the user.

In response to receiving a drawing command through the inputter 20, the processor 50 may control the display 31 to display a drawing screen, recognize touch position information received in the inputter 20 while the drawing screen is displayed, obtain drawing information based on the recognized touch position information, and recognize the obtained drawing information as the pattern information selected by the user.

The processor 50 may obtain alignment direction information of pattern based on the selected pattern information and shape information of the work area, and generate travel path information of the moving robot based on the obtained alignment direction information of the pattern.

As shown in FIG. 9A, basic travel path information corresponding to pattern information may be stored in advance. In this case, as shown in FIG. 9B, the processor 50 may confirm the basic travel path information corresponding to the selected pattern information, and correct the pre-stored basic travel path information based on the shape information of the work area.

The processor 50 may obtain the alignment direction information of the pattern that minimizes a working time for lawn care, based on the shape information of the work area, size information of the work area, and the selected pattern information, and may control the display 31 to display the obtained alignment direction information of the pattern.

The processor 50 may also control the communicator 40 to transmit the obtained alignment direction information of the pattern to the user device 2.

For example, as shown in FIG. 10A, based on the selected pattern information being grid pattern information, the processor 50 may obtain alignment direction information of the pattern that minimizes a working time for lawn care, and control the display 31 to display the obtained alignment direction information of the pattern.

In response to receiving a command to start lawn care through the inputter 20 in a state where the alignment direction information of the pattern is displayed, the processor 50 may control the first motor 1d to allow the moving robot 1 to move based on the obtained travel path information.

In response to receiving a command to start correction through the inputter 20 in a state where the alignment direction information of the pattern is displayed, the processor 50 may control the display 31 to display the shape information of the work area. In response to receiving alignment direction information of the pattern through the inputter 20 in a state where the shape information of the work area is displayed, the processor 50 may correct the alignment direction information of the pattern in the work area based on the received alignment direction information of the pattern.

For example, as shown in FIG. 10B, the processor 50 may correct the alignment direction information of the pattern in the work area based on the alignment direction information of the pattern received through the inputter 20, and may control the display 31 to display the corrected alignment direction information of the pattern in the work area.

The processor 50 may obtain estimated working time information required for lawn care, based on the corrected alignment direction information of the pattern, and control the display 31 to display the obtained estimated working time information.

In response to receiving a command to start lawn care through the inputter 20 in a state where the corrected alignment direction information of the pattern is displayed, the processor 50 may obtain travel path information based on the corrected alignment direction information of the pattern and the shape information of the work area, and may control the first motor 1d to allow the moving robot to move based on the obtained travel path information.

As shown in FIG. 11, the processor 50 may obtain alignment direction information of a pattern based on shape information of a work area and selected pattern information, and may control the display 31 to display the obtained alignment direction information of the pattern.

The processor 50 may obtain the alignment direction information of the pattern that aligns on a boundary or wall, based on the shape information of the work area.

The processor 50 may obtain initial posture information of the moving robot, obtain the alignment direction information of the pattern based on the obtained initial posture information, the shape information of the work area, and the selected pattern information, and may control the display 31 to display the obtained alignment direction information of the pattern.

The initial posture information of the moving robot 1 may include initial location information and initial direction information of the moving robot.

The processor 50 may obtain alignment direction information of a pattern based on a minimum time, a boundary, and an initial posture of the moving robot, and may control the display 31 to display the obtained alignment direction information of the pattern as recommended pattern alignment direction information.

In a case where a plurality of pieces of recommended pattern alignment direction information exist, in response to receiving a pattern selection command through the inputter 20, the processor 50 may obtain alignment direction information of a pattern selected by a user based on the received pattern selection command.

In response to receiving a command to start correction through the inputter 20, the processor 50 may perform a correction mode, and in response to receiving alignment direction information of pattern through the inputter 20 during the correction mode, the processor 50 may control the display 31 to display the alignment direction information of the pattern in the work area, based on the received alignment direction information of the pattern.

The processor 50 may control a height of the blade Ic and an operation of the second motor 1e, based on an operation type received through the inputter 20, the selected pattern information, and travel path information.

In response to the pattern information received in the inputter 20 being non-pattern information, the processor 50 may generate travel path information based on the shape information of the work area, and control an operation of the first motor 1d to allow the moving robot to move based on the generated travel path information.

In response to the pattern information received in the inputter 20 being non-pattern information, the processor 50 may generate travel path information that minimizes a working time based on the shape information of the work area.

The processor 50 may also determine an operation type of lawn care based on the shape information of the work area, size information of the work area, and the selected pattern information.

The operation type may include a first operation type that flattens grass by applying pressure, a second operation type that varies a grass height depending on whether cutting is performed or not, and a third operation type that changes a grass height according to a change in grass cutting height.

As shown in FIG. 12A and FIG. 12B, the first operation type is to cause the grass to be slightly flattened in a direction corresponding to a traveling direction of the moving robot by a roller or striping kit provided in the moving robot. In this case, the direction in which the grass lies down may affect light reflection, causing a color of grass to appear differently to human eyes.

As shown in FIG. 13A and FIG. 13B, the second operation type is to cause a height difference between cut grass and uncut grass by cutting the grass in some part of the work area and not cutting the grass in the remaining part of the work area. In this case, a color of grass may appear differently to human eyes depending on the difference in grass height.

As shown in FIG. 14A and FIG. 14B, the third operation type is to cause a height difference for each part of the work area by cutting the grass in some part of the work area to a first height and cutting the grass in the remaining part to a second height. In this case, a color of grass may appear differently to human eyes depending on the difference in grass height.

In response to the operation type being the first operation type or the second operation type, the processor 50 may adjust a height of the blade Ic to a preset height, and control the blade Ic adjusted to the preset height to perform lawn care.

The processor 50 may adjust the height of the blade Ic in response to a user input received through the inputter 20, and perform lawn work with the adjusted height of the blade 1c. The first operation type or the second operation type may be the operation type used to perform lawn work with the adjusted height of the blade 1c.

The processor 50 may adjust the height of the blade Ic based on the operation type received through the inputter 20. In this case, in response to the received operation type being the first operation type, the processor 50 may adjust the height of the blade to a preset height or a height set by a user, and control the second motor to cut the grass based on travel path information and selected pattern information, and control the roller (not shown) or the striping kit (not shown) to apply pressure on the grass.

In response to the received operation type being the second operation type, the processor 50 may adjust the height of the blade to a preset height or a height set by the user, and control the second motor to perform or stop an operation of cutting the grass based on travel path information and selected pattern information.

In response to the received operation type being the third operation type, the processor 50 may adjust the height of the blade to a first height or a second height, and control the second motor to cut the grass based on travel path information and selected pattern information.

The processor 50 may control a rotational speed of the second motor based on travel path information.

The processor 50 may determine whether to change a traveling direction of the moving robot based on the travel path information, and based on a determination that the traveling direction is to be changed, the processor 50 may stop a rotation of the second motor or control to reduce the rotational speed of the second motor.

The processor 50 may determine whether to change a traveling direction of the moving robot based on the travel path information, and based on a determination that the traveling direction is to be changed, the processor 50 may obtain an angle corresponding to the traveling direction and control to reduce the rotational speed of the second motor 1e based on the angle.

In response to receiving a pattern download command through the inputter 20, the processor 50 may control communication with the selected server 3, and in response to the processor 50 being communicatively connected to the server 3, may request provision of pattern information through the server 3. In response to receiving the pattern information from the server 3, the processor 50 may control the pattern information stored in the server 3 to be downloaded, and control the downloaded pattern information to be stored.

In response to a pattern download command, the processor 50 may also control pattern information to be downloaded from the user device 2.

In response to receiving a pattern upload command through the inputter 20 after lawn care is completed, the processor 50 may transmit shape information of the work area, size information of the work area, pattern information, alignment direction information of a pattern, and working time information to the server 3. In this case, the server 3 may store the shape information of the work area, the size information of the work area, the pattern information, the alignment direction information of the pattern, and the working time information received from the moving robot.

The processor 50 may control the outputter 30 to output travel information and state information of the moving robot.

The processor 50 may confirm required charging amount of the battery 80 based on the shape information of the work area, the size information of the work area, and the selected pattern information, and may control the display 31 to display information about the amount of work that may be performed out of the total amount of work for the work area, based on the current charging amount of the battery and the confirmed required charging amount.

The processor 50 may obtain the number of battery charges required for lawn care of the entire work area and a charging time per charge of the battery, based on the required charging amount of the battery, and may control the display 31 to display the obtained number of battery charges and the charging time per charge of the battery.

The processor 50 may obtain traveling speed information of the moving robot based on a rotational speed of the first motor connected to the wheels provided on the left and right sides of the main body.

The processor 50 may obtain an estimated working time based on the shape information of the work area, the size information of the work area, the pattern information, and the traveling speed information of the moving robot, and may control displaying of the obtained estimated working time.

The processor 50 may control the speaker 32 to output notification information that the battery requires charging as sound, and may control the speaker 32 to output notification information indicating a start and end of lawn care as sound.

The processor 50 may also control the speaker 32 to output notification information to notify a malfunction of the moving robot as sound.

The moving robot 1 may further include a storage container for storing white ash powder or lime powder, and an opening and closing member for opening and closing an opening provided in the storage container. In this case, in response to receiving a test command through the inputter, the processor 50 may control an operation of the first motor based on the travel path information, and control the opening or closing of the opening and closing member based on the selected pattern information. The processor 50 may generate a test pattern in a portion of the work area or entire work area, and in response to the test pattern being completely generated, the processor 50 may display test completion information through the display or control the communicator to transmit the test completion information to the user device.

The memory 51 may store an algorithm for controlling operations of internal components of the moving robot 1 or data about a program that reproduces the algorithm.

The memory 51 may store position coordinate information of the moving robot 1 determined based on a user input which is input through the inputter 20 and location information of the beacons 100.

Also, the memory 51 may store the location information of the beacons 100. That is, a user may input information about the position coordinates of the beacons 100, installed in the work area of the moving robot 1, to the moving robot 1 through the inputter 20. In this instance, the position coordinate information input to the inputter 20 may be stored in the memory 51.

The memory 51 may store pattern information about a plurality of patterns.

The memory 51 may store basic travel path information of the moving robot corresponding to the pattern information.

For example, the memory 51 may store a travel path that the moving robot requires to travel to mow the grass in a check pattern, striped pattern, wave pattern, and the like, in the work area.

The memory 51 may store size information and shape information of the work area corresponding to the position coordinates of the beacons 100.

The memory 51 may store pattern information selected by a user, and a working time taken for lawn care work in the selected pattern.

The pattern information selected by the user may be pattern information recommended by the moving robot, pattern information corrected by the user, or pattern information drawn by the user.

The memory 51 may store state-of-charge information corresponding to a voltage of the battery as a map, may store state-of-charge information of the battery corresponding to a voltage and a current of the battery as a map, or may store state-of-charge information of the battery corresponding to a voltage, a current, and a temperature of the battery as a map.

The memory 51 may store information about the amount of battery discharge consumed during simultaneous operation of the first motors 1d and the second motor 1e as a first map, and store information about the amount of battery discharge consumed during the operation of the first motors 1d as a second map.

Here, the information about the amount of battery discharge may be state-of-charge information of the battery.

The memory 51 may include travelable distance information corresponding to the state-of-charge information of the battery.

The memory 51 may store a target rotational speed of the first motor connected to the left wheel and a target rotational speed of the first motor connected to the right wheel corresponding to a traveling direction of the moving robot.

The memory 51 may store a target rotational speed of the first motor connected to the left wheel and a target rotational speed of the first motor connected to the right wheel corresponding to a rotation angle of the moving robot.

The memory 51 may be implemented with at least one of a volatile memory such as a

Random Access Memory (RAM), a non-volatile memory such as a cache, a Read Only Memory (ROM), a Programmable Read Only Memory (PROM), an Erasable Programmable Read Only Memory (EPROM), and an Electrically Erasable Programmable Read Only Memory (EEPROM) and flash memory, or storage medium such as Hard Disk Drive (HDD) and Compact Disc Read Only Memory (CD-ROM), without being limited thereto.

The memory 51 and the processor 50 may be implemented as separate chips. Alternatively, the memory 51 and processor 50 may be implemented as a single chip.

The first motor driver 60 may be connected to the plurality of first motors 1d.

The first motor driver 60 may control the plurality of first motors according to a control command of the processor 50.

The first motor driver 60 may rotate the plurality of first motors at different target rotational speeds, and rotate the plurality of first motors at the same target rotational speed according to a control command of the processor 50.

The first motor driver 60 may include an inverter.

The second motor driver 70 may be connected to the second motor 1e.

The second motor driver 70 may rotate the second motor 1e at a target rotational speed of the second motor 1e according to a control command of the processor 50.

The second motor driver 70 may include an inverter.

The battery 80 supplies power required for an operation of the moving robot.

The battery 80 may be a rechargeable battery. The battery 80 may be charged by docking the moving robot 1 to a charging station (not shown).

The battery manager 81 may monitor a charging state of the battery and transmit state-of-charge information to the processor 50.

The battery manager 81 may include a voltage sensor detecting a voltage of the battery, a current sensor detecting a current of the battery, and a temperature sensor detecting a temperature of the battery, and may monitor a charging state of the battery based on the voltage, current, and temperature of the battery.

The battery manager 81 may determine whether the battery 80 is fully charged based on the state-of-charge information of the battery 80, and based on a determination that the battery 80 is fully charged, the battery manager 81 may transmit charge completion information to the processor 50.

At least one component may be added or omitted corresponding to the performance of the components of the moving robot 1 illustrated in FIG. 7. Also, it will be easily understood by those skilled in the art that mutual positions of the components may be modified corresponding to the performance or structure of the moving robot.

Meanwhile, each of the components shown in FIG. 7 refers to a software and/or hardware component such as a Field-Programmable Gate Array (FPGA) or an Application-Specific Integrated Circuit (ASIC).

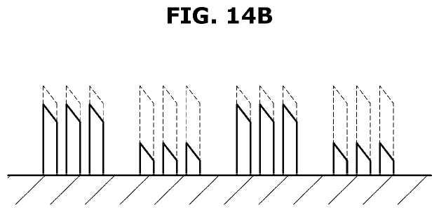

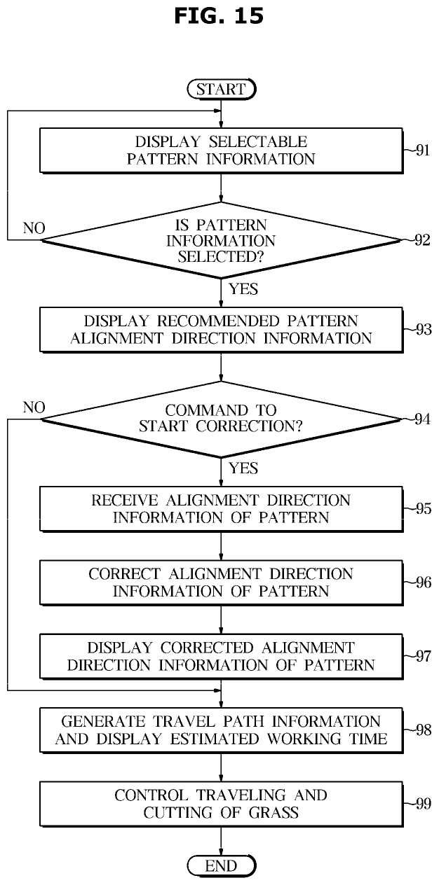

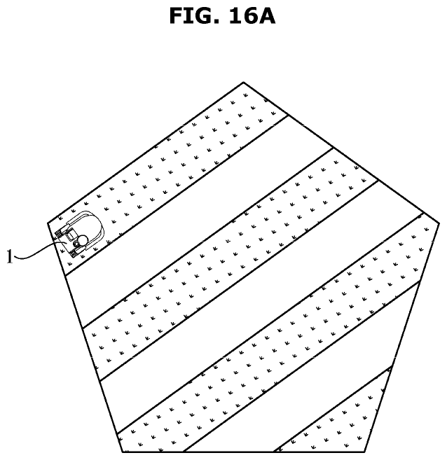

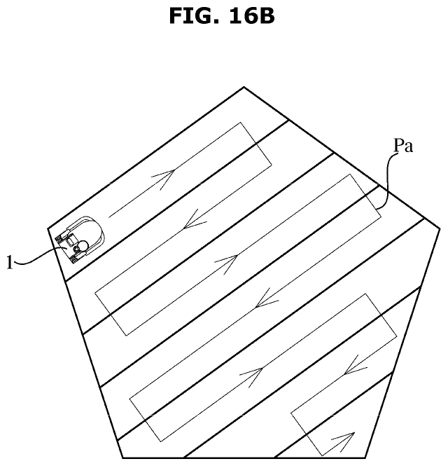

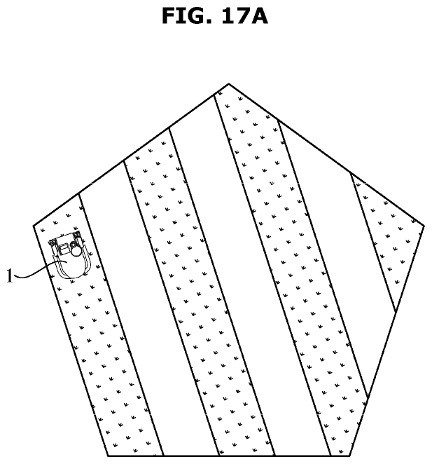

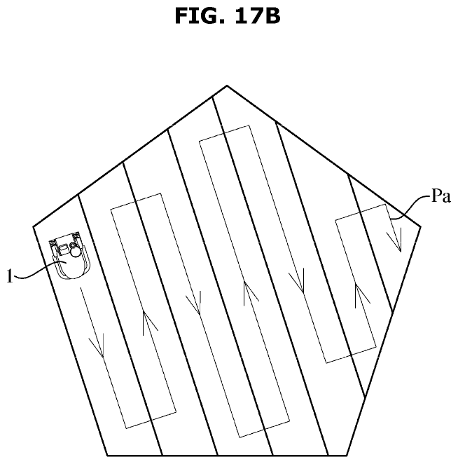

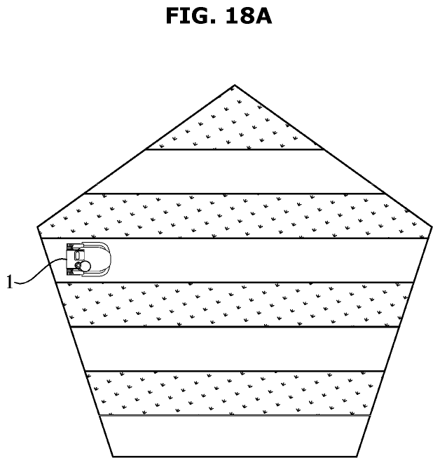

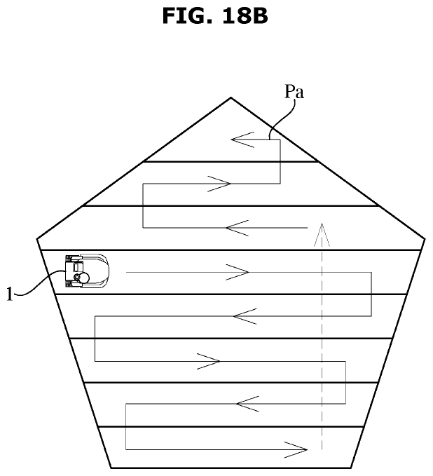

FIG. 15 is a flowchart of a control method of a moving robot according to an embodiment, which is described with reference to FIG. 16A, FIG. 16B, FIG. 17A, FIG. 17B, FIG. 18A and FIG. 18B.

FIG. 16A and FIG. 16B illustrate an example of minimum time-based alignment direction information and travel path information of a pattern in a work area. FIG. 17A and FIG. 17B illustrate an example of boundary-based alignment direction information and travel path information of a pattern in a work area. FIG. 18A and FIG. 18B illustrate an example of initial posture-based alignment direction information and travel path information of a pattern in a work area.

In response to receiving a power-on command through the inputter 20, the moving robot 1 may activate the display 31.

In response to receiving a pattern display command through the inputter 20, the moving robot 1 may display pattern information selectable by a user through the display 31 (operation 91).

The pattern information selectable by the user is pattern information to be mowed in a work area, may include pattern information pre-stored in the memory 51, and may further include non-pattern information and drawing information that allows the user to directly draw a desired pattern.

In response to receiving a pattern selection command through the inputter 20 (operation 92), the moving robot 1 may display pattern information selected by the user through the display 31.

In response to receiving a drawing command through the inputter 20, the moving robot 1 may display a drawing screen through the display 31, recognize touch position information received in the inputter 20 while the drawing screen is displayed, obtain drawing information based on the recognized touch position information, and recognize the obtained drawing information as the pattern information selected by the user.

The moving robot 1 may obtain alignment direction information of a pattern based on shape information of the work area and the selected pattern information, and generate travel path information of the moving robot based on the obtained alignment direction information of the pattern.

The moving robot 1 may also obtain the alignment direction information of the pattern based on the shape information of the work area, size information of the work area, and the selected pattern information.

The moving robot 1 may also obtain the alignment direction information of the pattern based on the shape information of the work area, initial posture information of the moving robot, and the selected pattern information.

That is, the moving robot 1 may obtain the alignment direction information of the pattern based on at least one of minimum time, boundary, or initial posture, may obtain recommended pattern alignment direction information as the obtained alignment direction information of the pattern, and may display recommended pattern alignment direction information that matches the work area through the display 31 (operation 93).

The moving robot 1 may transmit the recommended pattern alignment direction information that matches the work area to a user device 2. In this case, in response to receiving the recommended pattern alignment direction information that matches the work area from the moving robot, the user device 2 may display the recommended pattern alignment direction information that matches the work area.

As shown in FIG. 16A, the moving robot 1 may obtain alignment direction information of a pattern that minimizes a working time for lawn care, based on the shape information of the work area, the size information of the work area, and the selected pattern information.

As shown in FIG. 16B, the moving robot 1 may generate travel path information Pa of the moving robot based on the alignment direction information of the pattern obtained based on a minimum time.

As shown in FIG. 17A, the moving robot 1 may obtain location information of boundary based on the shape information of the work area, and obtain stable alignment direction information of the pattern based on the obtained location information of boundary and the selected pattern information.

As shown in FIG. 17B, the moving robot 1 may generate travel path information Pa of the moving robot based on alignment direction information of the pattern obtained based on the boundary.

As shown in FIG. 18A, the moving robot 1 may obtain alignment direction information of the pattern based on the shape information of the work area, initial posture information of the moving robot, and the selected pattern information.

Posture information of the moving robot 1 may include initial location information and initial direction information of the moving robot in the work area. The initial direction information may include direction information corresponding to a front of the moving robot.

As shown in FIG. 18B, the moving robot 1 may generate travel path information Pa of the moving robot based on the alignment direction information of the pattern obtained based on the initial posture.

The moving robot 1 may obtain an estimated working time based on the generated travel path information, and display the obtained estimated working time through the display.

The moving robot 1 may display the estimated working time corresponding to minimum time-based travel path information, the estimated working time corresponding to boundary-based travel path information, and the estimated working time corresponding to initial posture-based travel path information, respectively.

The moving robot 1 may obtain an estimated working time based on the shape information of the work area, the size information of the work area, and the travel path information. The moving robot 1 may also obtain an estimated working time based on the shape information of the work area, the size information of the work area, the travel path information, and traveling speed information of the moving robot.

In response to receiving a command to start correction through the inputter 20 (operation 94), the moving robot 1 may perform a correction mode. In response to receiving alignment direction information of a pattern through the inputter 20 during the correction mode (operation 95), the moving robot 1 may correct the alignment direction information of the pattern in the work area based on the received alignment direction information of the pattern (operation 96). The moving robot 1 may display the corrected alignment direction information of the pattern in the work area through the display 31 (operation 97).

The moving robot 1 may generate travel path information based on the corrected alignment direction information of the pattern in the work area (operation 98), obtain an estimated working time corresponding to the generated travel path information, and display the obtained estimated working time through the display 31 (operation 98).

In response to receiving a command to start lawn care through the inputter 20, the moving robot 1 may control traveling of the moving robot based on the obtained travel path information. While controlling the traveling of the moving robot, the moving robot 1 may control an operation of the first motor 1d as well as a rotational speed and rotation direction of the first motor.

The moving robot 1 may control a height of the blade Ic and an operation of the second motor 1e based on an operation type received through the inputter 20, the selected pattern information, and the travel path information. The moving robot 1 may control cutting of the grass by controlling the height and the operation of the blade (operation 99).

The moving robot 1 may adjust the height of the blade Ic according to a user input received through the inputter 20, or adjust the height of the blade Ic to a preset height.

In response to the pattern information received in the inputter 20 being non-pattern information, the moving robot 1 may generate travel path information based on the shape information of the work area, and control the first motor 1d and the second motor to operate simultaneously based on the generated travel path information, while controlling the operation of the first motor 1d and the second motor 1e.

In response to the pattern information received in the inputter 20 being non-pattern information, the moving robot 1 may generate travel path information that minimizes a working time based on the shape information of the work area.

The moving robot 1 may also determine an operation type of lawn care based on the shape information of the work area, the size information of the work area, and the selected pattern information.

The operation type may include a first operation type that flattens grass by applying pressure, a second operation type that varies a grass height depending on whether cutting is performed or not, and a third operation type that changes a grass height according to a change in grass cutting height.

In the first operation type, the moving robot 1 may adjust the height of the blade to a preset height or to a height set by a user, control the second motor to cut the grass based on the travel path information and the selected pattern information, and control a roller (not shown) or a striping kit (not shown) to apply pressure on the grass.

In the second operation type, the moving robot 1 may adjust the height of the blade to a preset height or to a height set by a user, and control the second motor 1e to cut the grass or not to cut the grass based on the travel path information and the selected pattern information.

In the third operation type, the moving robot 1 may adjust the height of the blade to a first height or a second height based on travel path information and the selected pattern information, and control the second motor to cut the grass.

The moving robot 1 may control a rotational speed of the second motor 1e based on the travel path information.

The moving robot 1 may determine whether to change a traveling direction of the moving robot based on the travel path information, and based on a determination that the traveling direction is to be changed, the moving robot 1 may stop a rotation of the second motor or control to reduce the rotational speed of the second motor 1e.

The moving robot 1 may determine whether to change a traveling direction of the moving robot based on the travel path information, and based on a determination that the traveling direction is to be changed, the moving robot 1 may obtain an angle corresponding to the traveling direction and control to reduce the rotational speed of the second motor 1e based on the angle.

In response to receiving a command to start lawn care or a command to finish a lawn care, the moving robot 1 may transmit the selected pattern information, the alignment direction information of the pattern, and the working time information to the server 3.

The moving robot 1 may determine whether the lawn care is completed based on the generated travel path information, and based on a determination that the lawn care is completed, the moving robot 1 may transmit the selected pattern information, the alignment direction information of the pattern, and the working time information to the server 3.

The moving robot 1 may also determine whether lawn care is completed based on the shape information of the work area, the size information of the work area, the selected pattern information, the alignment direction information of the pattern, and the generated travel path information.

In response to receiving a pattern upload command through the inputter 20, the moving robot 1 may transmit, to the server 3, the shape information of the work area, the size information of the work area, the selected pattern information, the alignment direction information of the pattern, and the working time information. In this case, the server 3 may store the shape information of the work area, the size information of the work area, the selected pattern information, the alignment direction information of the pattern, and the working time information received from the moving robot.

In response to receiving a pattern download command through the inputter 20, the moving robot 1 may control communication with the selected server 3, and in response to being communicatively connected to the server 3, the moving robot 1 may request the server 3 to provide pattern information. In response to receiving the pattern information from the server 3, the moving robot 1 may control the pattern information stored in the server 3 to be downloaded, and control the downloaded pattern information to be stored.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be a Read Only Memory (ROM), a Random Access Memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. A moving robot, comprising:
a main body;
a plurality of wheels configured to rotate to move the main body;
a blade provided to the main body and configured to be rotatable to cut grass; and
at least one processor configured to:
obtain alignment direction information of a pattern by which the main body is movable based on pattern information and shape information of a work area,
generate travel path information based on the obtained alignment direction information of the pattern,
control the plurality of wheels to rotate to move the main body based on the generated travel path information, and
control the blade to rotate to cut grass based on the generated travel path information.

2. The moving robot of claim 1, further comprising:
a communicator configured to communicate with a plurality of beacons, each of which is located at different positions in the work area,
wherein the at least one processor is configured to, in response to receiving location information from the plurality of beacons, obtain the shape information of the work area and size information of the work area based on the received location information from the plurality of beacons.

3. The moving robot of claim 2, wherein
the at least one processor is configured to:
obtain the alignment direction information of the pattern that minimizes a working time for lawn care to be performed by the moving robot, based on
the shape information of the work area,
the size information of the work area, and
the pattern information.

4. The moving robot of claim 2, wherein
the at least one processor is configured to:
obtain location information of a boundary based on the shape information of the work area, and
obtain the alignment direction information of the pattern based on the obtained location information of the boundary and the pattern information.

5. The moving robot of claim 1, further comprising:
an inputter configured to receive the pattern information.

6. The moving robot of claim 5, further comprising:
a communicator configured to communicate with a plurality of beacons, each of which is located at different positions in the work area,
wherein the at least one processor is configured to, in response to receiving non-pattern information through the inputter:
obtain current location information of the main body based on communication signals with the plurality of beacons, and
generate the travel path information that minimizes a working time for lawn care to be performed by the moving robot based on
the obtained current location information of the main body, and
the shape information of the work area.

7. The moving robot of claim 1, further comprising:
a communicator configured to communicate with a user device; and
a display,
wherein the at least one processor is configured to:
control the display to display the obtained alignment direction information of the pattern, or
control the communicator to transmit the obtained alignment direction information of the pattern to the user device.

8. The moving robot of claim 7, wherein
the at least one processor is configured to:
obtain estimated working time information based on the generated travel path information, and
control the display to display the obtained estimated working time information.

9. The moving robot of claim 7, further comprising:
an inputter configured to receive the pattern information,
wherein the at least one processor is configured to, in response to receiving the alignment direction information of a pattern through the inputter:
correct the received alignment direction information of the pattern in the work area, and
control the display to display the corrected alignment direction information of the pattern in the work area.

10. The moving robot of claim 9, wherein
the at least one processor is configured to:
generate the travel path information based on the corrected alignment direction information of the pattern in the work area,
obtain estimated working time information based on the generated travel path information, and
control the display to display the obtained estimated working time information.

11. The moving robot of claim 1, wherein
the at least one processor is configured to, when controlling the plurality of wheels to rotate to move the main body based on the generated travel path information, control a rotational speed of the blade to be reduced in response to changing a traveling direction of the main body.

12. The moving robot of claim 1, further comprising:
a communicator configured to communicate with a server,
wherein the at least one processor is configured to, in response to a lawn care operation being completed, control the communicator to transmit at least one of the shape information of the work area, the pattern information, the alignment direction information of the pattern, and the generated travel path information to the server.

13. The moving robot of claim 12, wherein
the at least one processor is configured to receive at least one of the pattern information, the shape information of the work area, and size information of the work area from the server.

14. The moving robot of claim 1, wherein
the at least one processor is configured to control a rotational speed of the plurality of wheels based on the generated travel path information and the pattern information.

15. The moving robot of claim 1, further comprising:
an inputter configured to receive the pattern information,
wherein the at least one processor is configured to control
a height of the blade,
a rotational speed of the blade, and
rotation and stoppage of the blade, based on
an operation type received through the inputter,
the pattern information, and
the generated travel path information.
